(19) United States
(12) Patent Application Publication
(10) Pub. No.: US 2011/0269435 A1
(43) Pub. Date: Nov. 3, 2011

(54) AUTOMATIC ICONIC DISPLAY OF CALENDAR EVENTS ON COMPUTING DEVICES BY INSPECTING EVENTS TEXT

(76) Inventor: TIM DIECKMAN, San Francisco, CA (US)

(21) Appl. No.: 13/096,346

(22) Filed: Apr. 28, 2011

Related U.S. Application Data
(60) Provisional application No. 61/330,114, filed on Apr. 30, 2010.

(51) Int. Cl. G06F 17/30; G06F 3/048; H04M 3/42

(52) U.S. Cl. 455/414.1; 707/772; 715/772; 707/E17.014

(57) ABSTRACT

A system and method for displaying text calendar entries as an iconic display that automatically selects a picture and extracts useful text to show as the calendar display by inspecting each calendar entry's text. The picture used may be determined from a database of pictures and keywords. The database may be on a computing device that has a calendar feature (such as a smart phone, a computer, or the like) or may reside on a separate server that the computing device may access via, for example, an internet connection.

### CROSS-REFERENCE TO RELATED APPLICATIONS

This application claims the benefit of priority of U.S. provisional patent application No. 61/330,114, filed Apr. 30, 2010, the contents of which are herein incorporated by reference.

### BACKGROUND OF THE INVENTION

The present invention relates to electronic calendars and, more particularly, to a system and method that reviews the text of a calendar event to provide an iconic representation of the event.

Currently, a user of a computing device who wants to view their calendar agenda sees a list of events displaying the time and text of the events. Text requires concentration from the user for full comprehension. In addition, the display of all the events' text takes up a lot of screen space, which can be a premium on small computing devices, such as smart phones.

As can be seen, there is a need for a system and apparatus that can provide an iconic display of calendar events.

### SUMMARY OF THE INVENTION

In one aspect of the present invention, a computer readable medium having computer usable program code embodied therewith, the computer program code comprises computer program code configured to retrieve data from a user's calendar; computer program code configured to inspect the words from an event on the user's calendar; and computer program code configured to compare the words to a word database to determine an image to display to the user and to determine what rule to use for determining text to be displayed with the image.

In another aspect of the present invention, a calendar system on a computing device comprises an iconic display of a textual calendar event, the iconic display appearing automatically on a calendar display, the iconic display based on a comparison of words in the text of the calendar event to a database of words.

In a further aspect of the present invention, a method of automatically displaying calendar events as iconic calendar displays comprise retrieving data from a user's calendar; inspecting the words from an event on the user's calendar; and comparing the words to a word database to determine an image to display to the user and to determine what rule to use for determining text to be displayed with the image; wherein the rule for determining text to be displayed with the image includes at least one of a rule to display the event time, a rule to display no text, a rule to display pre-defined text; a rule to display one or more words from words of the event; and a rule to display text manipulation.

These and other features, aspects and advantages of the present invention will become better understood with reference to the following drawings, description and claims.

### BRIEF DESCRIPTION OF THE DRAWINGS

FIG. 1 is a system flow chart of an iconic display system and method according to an exemplary embodiment of the present invention;

FIG. 2 is a diagram of calendar event data used in the iconic display system of FIG. 1; and

FIG. 3 is a functional diagram of the calendar event data of FIG. 2 as converted into an iconic display according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an apparatus and method for displaying standard text calendar entries as an iconic display. The system of the present invention may automatically select a picture and extract useful text to show on the calendar display. The picture used and the text extracted may be determined from a database of pictures and keywords. The database may be on a computing device that has a calendar feature (such as a smart phone, a computer, or the like) or may reside on a separate server that the computing device may access via, for example, an internet connection.

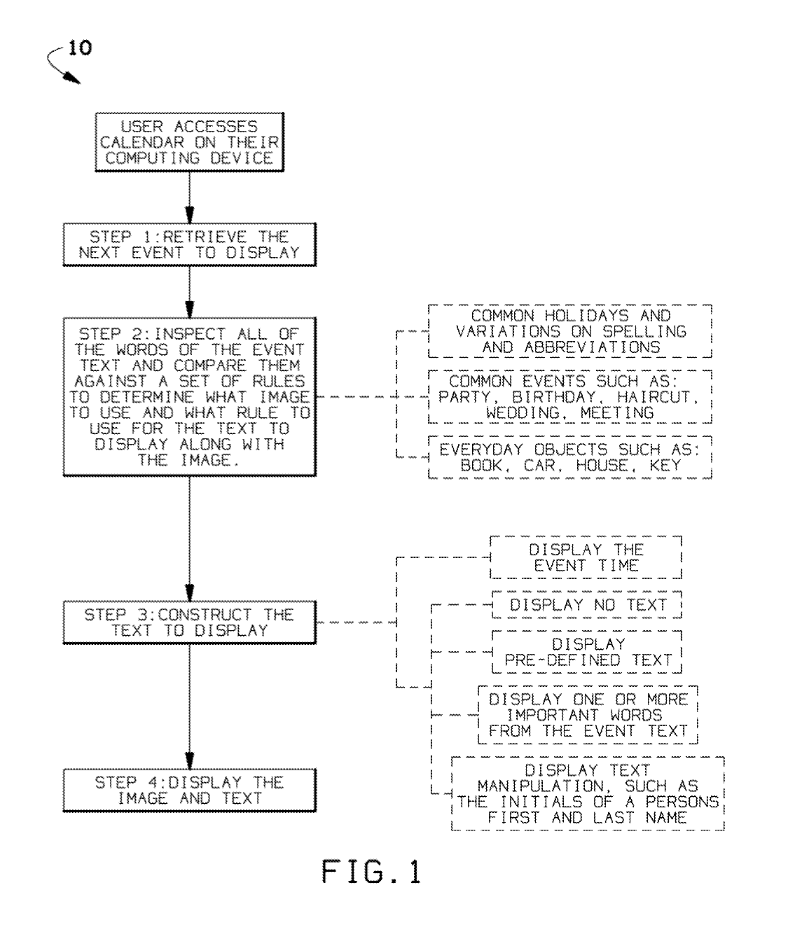

Referring to FIG. 1, a flow chart 10 describes an exemplary process flow for the system and method according to an exemplary embodiment of the present invention. When a user accesses their calendar on a computing device, such as a smart phone, for example, and attempts to retrieve the next event to display, the system of the present invention may inspect the words of the event text and compare them against a set of rules to determine what image to use and what rule to use for the text to display, if any, along with the image. The rules may be provided on a database. The database may be resident on the computing device or may be resident on a system separate from the computing device. When the database is on a separate system, the computing device may access the database and associated rules via a connection, such as an internet connection.

The rules may include words associated with the following exemplary events: 1) holidays and variations on spelling and abbreviations of holidays; 2) events, such as party, birthday, haircut, wedding, meeting, and the like; and 3) objects, such as book, car, house, key, and the like. Other words may be included in the rules. The user may have the ability to make up their own word database and associated rules. For example, if a user has events that may be unconventional, they may define words for the system to find and rules to display specific icons for these rules.

The system and method of the present invention may, once determining what icon to display, determine what text, if any, to display with the icon. The text may include one or more of the following: 1) the event time; 2) pre-defined text from the database; 3) selected words from the event text; and 4) text manipulations of the event text, such as the initials of a person's first and last name.

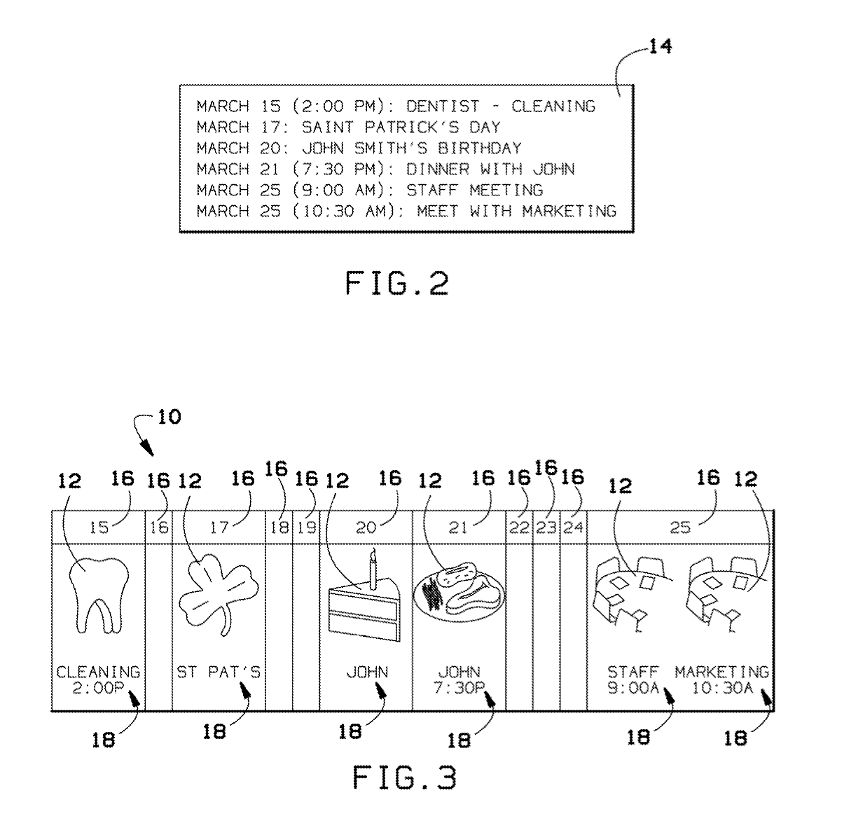

Referring to FIG. 2, calendar event data 14 may include the initial information that is part of a calendar event text. This text may be entered by a user or may be automatically entered as a result of the user receiving a calendar appointment.

The calendar event data 14 may be displayed as an iconic display as shown in FIG. 3. The iconic display may include an image 12 that may correspond to the event. For example, the system of the present invention may inspect the words of “Dentist-cleaning” and, as a result of seeing the word dentist, may display an icon of a tooth on an appropriate calendar date 16. The system may also extract a word from the calendar event data 14, in this case, “cleaning” to be displayed next to the icon.

In addition, the system may realize that this is an appointment and display the appointment time as part of event text 18. For a holiday, such as Saint Patrick's Day, the system may display a clover and the text “St Pat's”. No time may be displayed, as the system may realize that this event is not a specific appointment.

Similarly, a birthday, as shown on the date March 20, may not have a time shown. This example also shows how the system may manipulate text from the calendar event data 14, as the original text of “John Smith's Birthday” may be manipulated to simply John, with an icon of a birthday cake. Alternatively, the system may display initials, or the like. This action may be caused by the system finding the word “birthday” in the event text. The system may further recognize “John” as a first name. Alternatively, the systemmay simply assume that a name prior to birthday is the person having the birthday and show that name. The system of the present invention may include preference selections to determine certain aspects of the present invention, such as text manipulation or the like.

As a further example, “Dinner with John” on March 21 may be shown as a dinner plate icon, with the text “John” and the time of the appointment shown. In some embodiments, the system may recognize words such as “dinner”, “lunch” and “breakfast” and may provide different icons to quickly show the user the planned meal appointment.

As another example, meetings may be shown as a meeting table icon, with text indicating some aspect of the meeting (such as who the meeting is with) and the meeting time. The system may recognize the word “meeting” in the event text to create the iconic calendar entry. In some embodiments, the icon may differentiate between meetings for which the user is an invited guest as compared to meetings where the user organizes the meeting.

While the above describes the creation of an icon and text display when the user selects to view his or her calendar, the present invention may display incoming calendar events automatically as icons and selected text immediately upon entry into the user's calendar. In some embodiments, the user may be able to retrieve the original calendar appointment information by, for example, opening the appointment to see the details thereof.

The database of the system of the present invention may include a plurality of pre-assigned icons. For example, as discussed above, birthdays, meals, meetings, appointments, and the like, may have certain icons assigned thereto. The database may include other icons that the user may self-define to be associated with certain calendar text words.

The present invention may reside on software having code adapted to perform the various steps associated with the system and methods described above. As used herewithin, the term computer and reference to a computing device, may refer to any device having a processing unit, such as a personal computer (PC), a tablet PC, a netbook, a notebook, a smart phone, and similar devices.

It should be understood, of course, that the foregoing relates to exemplary embodiments of the invention and that modifications may be made without departing from the spirit and scope of the invention as set forth in the following claims.

What is claimed is:

1. A computer readable medium having computer usable program code embodied therewith, the computer program code comprising:
computer program code configured to retrieve data from a user's calendar;
computer program code configured to inspect words from an event on the user's calendar; and
computer program code configured to compare the words to a word database to determine an image to display to the user and to determine what rule to use for determining text to be displayed with the image.

2. The computer readable medium of claim 1, having computer program code wherein the rule for determining text to be displayed with the image includes at least one of a rule to display the event time, a rule to display no text, a rule to display pre-defined text; a rule to display one or more words from words of the event; and a rule to display text manipulation.

3. The computer readable medium of claim 1, further comprising computer program code to display the image and text on the user's calendar.

4. The computer readable medium of claim 1, having program code wherein the word database includes holidays, including spelling variations and abbreviations thereof, events, and objects.

5. The computer readable medium of claim 1, further comprising computer program code allowing a user to enter words into the word database.

6. A calendar system on a computing device, comprising:
an iconic display of a textual calendar event, the iconic display appearing automatically on a calendar display, the iconic display based on a comparison of words in the text of the calendar event to a database of words.

7. The calendar system of claim 6, further comprising a textual display including at least one of the event time, no text, pre-defined text; one or more words from words of the event; and text manipulation, the textual display dependent upon text of the textual calendar event.

8. The calendar system of claim 6, wherein the database of words is either integrated into the computing device or the database resides on a second computing device, the computing device having access to data on the second computing device.

9. The calendar system of claim 6, wherein the computing device is a smart phone.

10. A method of automatically displaying calendar events as iconic calendar displays, the method comprising:
retrieving data from a user's calendar;
inspecting the words from an event on the user's calendar; and
comparing the words to a word database to determine an image to display to the user and to determine what rule to use for determining text to be displayed with the image;
wherein the rule for determining text to be displayed with the image includes at least one of a rule to display the event time, a rule to display no text, a rule to display pre-defined text; a rule to display one or more words from words of the event; and a rule to display text manipulation.
